(19) United States
(12) Patent Application Publication
(10) Pub. No.: US 2021/0204149 A1
(43) Pub. Date: Jul. 1, 2021

(54) CONFIGURATION METHOD, RECEIVING METHOD, TERMINAL, AND NETWORK SIDE DEVICE

(71) Applicant: VIVO MOBILE COMMUNICATION CO., LTD., Dongguan (CN)

(72) Inventors: Boubacar KIMBA DIT ADAMOU, Dongguan (CN); Xiaodong YANG, Dongguan (CN); Qian ZHENG, Dongguan (CN)

(73) Assignee: VIVO MOBILE COMMUNICATION CO., LTD., Dongguan (CN)

(21) Appl. No.: 17/202,386

(22) Filed: Mar. 16, 2021

Related U.S. Application Data
(63) Continuation of application No. PCT/CN2019/105303, filed on Sep. 11, 2019.

(30) Foreign Application Priority Data
Sep. 25, 2018 (CN) 201811119982.0

(51) Int. Cl. H04W 24/02; H04W 76/27; H04W 56/00; H04W 88/06

(52) U.S. Cl. CPC H04W 24/02; H04W 88/06; H04W 56/001; H04W 76/27

(57) ABSTRACT

The present disclosure provides a configuration method, a receiving method, a terminal, and a network side device. The configuration method applied to the network side device includes sending first synchronization signal/physical broadcast channel (SS/PBCH) block measurement timing configuration (SMTC) configuration information, where the first SMTC configuration information is used by a terminal in an idle state or an inactive state.

### CROSS-REFERENCE OF RELATED APPLICATION

The application is a bypass continuation of PCT Application No. PCT/CN2019/105303 filed Sep. 11, 2019, which claims priority to Chinese Patent Application No. 201811119982.0 filed in China on Sep. 25, 2018, both of which are incorporated herein by reference in their entireties.

### TECHNICAL FIELD

Embodiments of the present disclosure relate to the field of communications technologies, and in particular, to a configuration method, a receiving method, a terminal, and a network side device.

### BACKGROUND

In a scenario of reselection, initiating a connection, or initiating recovery, a terminal in an idle state or an inactive state needs to read a synchronization signal/physical broadcast channel (SS/PBCH) block of a cell. The SS/PBCH block may also be referred to as a synchronization broadcast signal block.

However, in the related technologies, the terminal in the idle state or the inactive state reads the synchronization broadcast signal block of the cell through blind detection. As a result, power consumption of the terminal is increased.

### SUMMARY

The present disclosure is implemented as follows:

According to a first aspect, an embodiment of the present disclosure provides a configuration method, applied to a network side device. The configuration method includes: sending first SS/PBCH block measurement timing configuration (SMTC) configuration information, where the first SMTC configuration information is used by a terminal in an idle state or an inactive state.

According to a second aspect, an embodiment of the present disclosure provides a configuration method, applied to a terminal. The receiving method includes: receiving first SMTC configuration information of a first cell; and when the terminal is in an idle state or an inactive state, reading a synchronization broadcast signal block of the first cell according to the first SMTC configuration information.

According to a third aspect, an embodiment of the present disclosure further provides a network side device, including: a sending module, configured to send first synchronization broadcast signal block measurement timing configuration SMTC configuration information, where the first SMTC configuration information is used by a terminal in an idle state or an inactive state.

According to a fourth aspect, an embodiment of the present disclosure further provides a terminal, including: a first receiving module, configured to receive first SMTC configuration information of a first cell; and a read/measurement module, configured to: when the terminal is in an idle state or an inactive state, read a synchronization broadcast signal block of the first cell according to the first SMTC configuration information.

According to a fifth aspect, an embodiment of the present disclosure further provides a network side device, including: a processor, a memory, and a computer program stored in the memory and executable on the processor. The computer program, when executed by the processor, implements the steps of the foregoing configuration method.

According to a sixth aspect, an embodiment of the present disclosure further provides a terminal, including a processor, a memory, and a computer program stored in the memory and executable on the processor. The computer program, when executed by the processor, implements the steps of the foregoing receiving method.

According to a seventh aspect, an embodiment of the present disclosure further provides a computer readable storage medium. The computer readable storage medium stores a computer program. The computer program, when executed by a processor, implements the steps of the foregoing configuration method or the steps of the foregoing receiving method.

### BRIEF DESCRIPTION OF DRAWINGS

To describe the technical solutions of the embodiments of the present disclosure more clearly, the following briefly describes the accompanying drawings required for describing the embodiments of the present disclosure. Apparently, the accompanying drawings in the following description show merely some embodiments of the present disclosure, and a person of ordinary skill in the art may still derive other drawings from these accompanying drawings without creative efforts.

FIG. 1 is a structural diagram of a network system to which an embodiment of this disclosure may be applied;

FIG. 2 is a flowchart of a configuration method according to an embodiment of the present disclosure;

FIG. 3 is a flowchart of a receiving method according to an embodiment of the present disclosure;

FIG. 4 is a first structural diagram of a network side device according to an embodiment of the present disclosure;

FIG. 5 is a first structural diagram of a terminal according to an embodiment of the present disclosure;

FIG. 6 is a second structural diagram of a network side device according to an embodiment of the present disclosure; and

FIG. 7 is a second structural diagram of a terminal according to an embodiment of the present disclosure.

### DETAILED DESCRIPTION

The following clearly describes the technical solutions in the embodiments of the present disclosure with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

Terms “first” and “second” in this application are used to distinguish between similar objects, and do not need to be used to describe a specific order or sequence. In addition, terms “include”, “have”, and any modification thereof are intended to cover non-exclusive inclusion, for example, processes, methods, systems, products, or devices that contain a series of steps or units are not necessarily limited to those steps or units that are clearly listed, but may include other steps or units that are not clearly listed or are inherent to these processes, methods, products, or devices. In addition, “and/or” used in this application means at least one of the connected objects. For example, A and/or B and/or C represents the following seven cases: Only A exists, only B exists, only C exists, both A and B exist, both B and C exist, both A and C exist, or A, B, and C all exist.

Referring to FIG. 1, FIG. 1 is a structural diagram of a network system to which an embodiment of the present disclosure is applicable. As shown in FIG. 1, the network system includes a terminal 11 and a network side device 12. The terminal 11 and the network side device 12 may communicate with each other through a network.

In this embodiment of the present disclosure, the terminal 11 may be also referred to as a user terminal (User Equipment, UE). In a specific implementation, the terminal 11 may be a terminal-side device such as a mobile phone, a tablet personal computer, a laptop computer, a personal digital assistant (PDA), a mobile internet device (MID), a wearable device, or a vehicle-mounted device. It should be noted that a specific type of the terminal 11 is not limited in the embodiments of the present disclosure.

The network side device 12 may be a base station, a relay, an access point, or the like. The base station may be a base station (for example, a 5G NR NB) of 5G and later versions, or a base station (for example, an evolved NodeB (eNB)) in another communications system. It should be noted that a specific type of the network side device 12 is not limited in the embodiments of the present disclosure.

For ease of description, the following describes some content in the embodiments of the present disclosure:

In a long term evolution (LTE) system, measurement idle configuration information is used to indicate information about measurement that needs to be performed by the terminal in the idle state.

A location of a synchronization broadcast signal block of a new radio (NR) cell may change as at least one of slot periodicity, an offset parameter, or duration of the NR cell changes. A synchronous signal/physical broadcast channel block measurement timing configuration or synchronization broadcast signal block measurement timing configuration (SS/PBCH Block Measurement Timing Configuration, SMTC) provides a periodic location for reading the synchronization broadcast signal block of the NR cell to the UE. This can prevent the UE from blindly reading the location of the synchronization broadcast signal block, thereby shortening a time for reading the synchronization broadcast signal block, and reducing power consumption of the UE.

Certainly, the embodiments of the present disclosure may also be applied to an eLTE system.

The following describes the configuration method in the embodiments of the present disclosure.

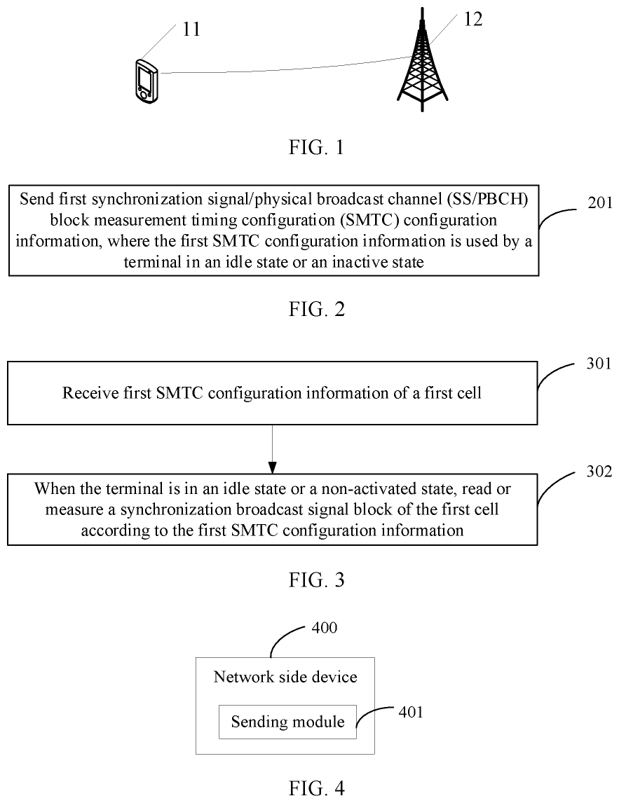

Referring to FIG. 2, FIG. 2 is a flowchart of a configuration method according to an embodiment of the present disclosure. The configuration method in this embodiment is applied to a network side device.

As shown in FIG. 2, the configuration method in this embodiment may include the following steps.

Step 201: Send first synchronization broadcast signal block measurement timing configuration SMTC configuration information, where the first SMTC configuration information is used by a terminal in an idle state or an inactive state.

In the embodiments, the first SMTC configuration information sent by the network side device is used by the terminal in the idle state or the inactive state. In other words, in the embodiments, the network side device may configure the first SMTC configuration information for UE in the idle state or the inactive state.

In a specific embodiment of the present disclosure, SMTC configuration information records a configuration of a period, an offset, and duration corresponding to an SSB of a target cell, and is configured based on timing reference of a primary cell. If the configuration information is empty, the terminal may use SMTC configuration information configured for a measurement object measObjectNR with a same subcarrier spacing of a same frequency.

The first SMTC configuration information is used to indicate the first location of the synchronization broadcast signal block of the cell. In this way, the UE may read or measure the synchronization broadcast signal block of the cell at the first location indicated by the received first SMTC configuration information, thereby accelerating reading or measurement of the synchronization broadcast signal block and reducing electricity consumption of the UE.

In actual application, the first location of the synchronization broadcast signal block of the cell may be determined according to a plurality of parameters. Therefore, the first SMTC configuration information may carry the parameter that affects determining of the first location of the synchronization broadcast signal block of the cell, to determine the first location of the synchronization broadcast signal block of the cell indicated by the SMTC configuration parameter.

Optionally, the first SMTC configuration information includes at least one of the following parameters:

a period parameter of the synchronization broadcast signal block, an offset parameter of the synchronization broadcast signal block, a window location parameter of an SMTC window, or a window length parameter of an SMTC window.

In this way, the UE may parse the parameter in the first SMTC configuration information, to determine the first location of the synchronization broadcast signal block indicated by the first SMTC configuration information, so that the first location of the synchronization broadcast signal block may be determined.

Further, the first SMTC configuration information corresponds to a frequency. In this way, the UE may determine the target cell based on the frequency corresponding to the first SMTC, so that the first location of the synchronization broadcast signal block of the target cell may be determined.

In some implementations, cell identity information may be also carried in the first SMTC configuration information. In this way, according to the first SMTC configuration information, the UE may directly determine the first location of the synchronization broadcast signal block of the cell indicated by the first SMTC configuration information, thereby accelerating the determining speed of the UE.

The cell identity information may be represented as cell list identification information and/or a cell frequency. Further, the cell frequency may include intra-frequency information or inter-frequency information.

In actual application, the first SMTC configuration information in the embodiments of the present disclosure may include at least one of the following:

cell list identification information;

cell frequency, including intra-frequency information or inter-frequency information;

list of a period parameter and an offset parameter of a synchronization broadcast signal block of each frequency; or

window location parameter and/or window length parameter of an SMTC window of a cell.

In actual application, the first SMTC configuration information may be carried in an idle state and/or inactive state configuration message, a broadcast message, or other radio resource control (RRC) messages (for example, a connection release message). Details may be determined according to the actual situation, and this is not limited in the embodiments of the present disclosure.

Optionally, the sending first SMTC configuration information includes:

when a terminal in a connected state is released to an idle state or an inactive state in a cell, sending a RRC connection release message, where the RRC connection release message carries first SMTC configuration information corresponding to a frequency; or

when a terminal in an idle state or an inactive state camps on a cell, broadcasting a system broadcasting message, where the system broadcasting message carries the first SMTC configuration information corresponding to a frequency, where

the cell is an LTE cell or a NR cell.

In this implementation, when the UE in a connected state that establishes an RRC connection with the cell is released to the idle state or the inactive state, the first SMTC configuration information corresponding to the frequency is carried in an RRC connection release message. In this way, the network side device does not need to configure SMTC configuration information for the UE by using other messages, thereby reducing signaling overheads.

When the terminal camping on the cell is always in the idle state or the inactive state, the first SMTC configuration information corresponding to the frequency is carried in a system broadcast message. In this way, the UE can receive the first SMTC configuration information corresponding to the frequency. Thus, the reliability of receiving the first SMTC configuration information by the UE can be improved.

Certainly, in some implementations, the first SMTC configuration information corresponding to the frequency may also be carried in dedicated signaling, for example, an idle state and/or inactive state configuration message, but is not limited thereto. In addition, in this implementation, the above cell may be an LTE cell or an NR cell, but is not limited thereto.

As can be seen, the configuration method of this implementation can improve the flexibility of sending the first SMTC configuration information and meet the requirements of various scenarios.

It should be noted that the plurality of optional implementations described in the embodiments of the present disclosure may be implemented in combination with each other or may be implemented separately. This is not limited in the embodiments of the present disclosure.

In the configuration method of this embodiment, the first synchronization broadcast signal block measurement timing configuration SMTC configuration information is sent, where the first SMTC configuration information is used by a terminal in an idle state or an inactive state. In this way, the terminal may also read or measure the synchronization broadcast signal block of the first cell in the idle state or the inactive state according to the received first SMTC configuration information of the first cell, thereby accelerating reading or measurement of the synchronization broadcast signal block and reducing electricity consumption of the terminal and power consumption of the terminal.

Specifically, the UE in the idle state or the inactive state can read or measure the synchronization broadcast signal block of the cell at the first location of the synchronization broadcast signal block of the cell indicated by the first SMTC configuration information of the cell in the scenario of reselection, initiating a connection, or initiating recovery, to accelerate the process of reselection, initiating a connection, or initiating recovery.

Referring to FIG. 3, FIG. 3 is a flowchart of a receiving method according to an embodiment of the present disclosure. The receiving method in this embodiment is applied to a terminal.

As shown in FIG. 3, the receiving method in this embodiment may include the following steps.

Step 301: Receive first SMTC configuration information of a first cell.

It should be noted that in the embodiments, the UE that receives the first SMTC configuration information of the first cell may be in the connected state, or may be in the idle state or the inactive state.

Step 302: When the terminal is in an idle state or an inactive state, read or measure a synchronization broadcast signal block of the first cell according to the first SMTC configuration information.

In specific implementation, if the terminal that receives the first SMTC configuration information is in the idle state or the inactive state, the terminal may determine the first location of the synchronization broadcast signal block of the first cell according to the first SMTC configuration information, and read or measure the synchronization broadcast signal block of the first cell at the first location.

Optionally, the first SMTC configuration information includes at least one of the following parameters:

a period parameter of the synchronization broadcast signal block, an offset parameter of the synchronization broadcast signal block, a window location parameter of an SMTC window, or a window length parameter of an SMTC window.

Optionally, the receiving first SMTC configuration information of a first cell includes:

when a terminal in a connected state is released to an idle state or an inactive state in a cell, receiving an RRC connection release message, where the RRC connection release message carries first SMTC configuration information corresponding to a frequency; or

when a terminal in an idle state or an inactive state camps on a cell, receiving a system broadcasting message, where the system broadcasting message carries the first SMTC configuration information corresponding to a frequency, where

the cell is an LTE cell or a NR cell.

It should be understood that locations of synchronization broadcast signal blocks of different cells may be different. Therefore, in the scenario in which the UE moves from the first cell to the second cell, optionally, after the receiving first SMTC configuration information of a first cell, the method further includes:

receiving second SMTC configuration information of a second cell, where the second SMTC configuration information is used to indicate a second location of a synchronization broadcast signal block of the second cell; and

when the second SMTC configuration information is different from the first SMTC configuration information, updating an SMTC configuration of the terminal to the second SMTC configuration information.

In this way, the UE may read the synchronization broadcast signal block of the second cell at the second location according to an updated SMTC configuration, thereby improving reliability of reading the synchronization broadcast signal block.

It should be noted that the plurality of optional implementations described in the embodiments of the present disclosure may be implemented in combination with each other or may be implemented separately. This is not limited in the embodiments of the present disclosure.

It should be noted that this embodiment serves as an implementation of a terminal corresponding to the foregoing method embodiment. Therefore, for related content, reference may be made to related description in the foregoing method embodiment, and same beneficial effects can be achieved. To avoid repeated description, details are not described herein again.

Referring to FIG. 4, FIG. 4 is a first structural diagram of a network side device according to an embodiment of the present disclosure. As shown in FIG. 4, the network side device 400 includes:

a sending module 401, configured to send first synchronization broadcast signal block measurement timing configuration SMTC configuration information, where the first SMTC configuration information is used by a terminal in an idle state or an inactive state.

Optionally, the first SMTC configuration information includes at least one of the following parameters:

a period parameter of the synchronization broadcast signal block, an offset parameter of the synchronization broadcast signal block, a window location parameter of an SMTC window, or a window length parameter of an SMTC window.

Optionally, the sending module 401 is specifically configured to:

when a terminal in a connected state is released to an idle state or an inactive state in a target cell, send a RRC connection release message, where the RRC connection release message carries first SMTC configuration information corresponding to a frequency; or

when a terminal in an idle state or an inactive state camps on a cell, broadcast a system broadcasting message, where the system broadcasting message carries the first SMTC configuration information corresponding to a frequency, where

the cell is an LTE cell or a NR cell.

The network side device 400 can implement each process in the foregoing method embodiments in FIG. 2 in the present disclosure, and achieve same beneficial effects. To avoid repetition, details are not described herein again.

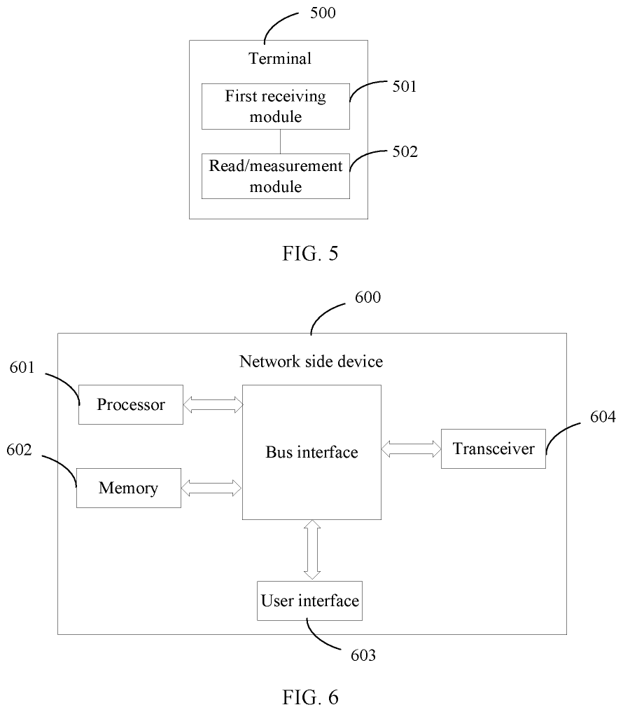

Referring to FIG. 5, FIG. 5 is a first structural diagram of a terminal according to an embodiment of the present disclosure. As shown in FIG. 5, the terminal 500 includes:

a first receiving module 501, configured to receive first SMTC configuration information of a first cell; and

a read/measurement module 502, configured to: when the terminal is in an idle state or an inactive state, read or measure a synchronization broadcast signal block of the first cell according to the first SMTC configuration information.

Optionally, the first SMTC configuration information includes at least one of the following parameters:

a period parameter of the synchronization broadcast signal block, an offset parameter of the synchronization broadcast signal block, a window location parameter of an SMTC window, or a window length parameter of an SMTC window.

Optionally, the first receiving module 501 is specifically configured to:

when a terminal in a connected state is released to an idle state or an inactive state in a cell, receive an RRC connection release message, where the RRC connection release message carries first SMTC configuration information corresponding to a frequency; or

when a terminal in an idle state or an inactive state camps on a cell, receive a system broadcasting message, where the system broadcasting message carries the first SMTC configuration information corresponding to a frequency, where

the cell is an LTE cell or a NR cell.

Optionally, the terminal 500 further includes:

a second receiving module, configured to: after the first SMTC configuration information of the first cell is received, receive second SMTC configuration information of a second cell, where the second SMTC configuration information is used to indicate a second location of a synchronization broadcast signal block of the second cell; and

an updating module, configured to: when the second SMTC configuration information is different from the first SMTC configuration information, update an SMTC configuration of the terminal to the second SMTC configuration information.

The terminal 500 can implement each process in the foregoing method embodiments in FIG. 3 in the present disclosure, and achieve same beneficial effects. To avoid repetition, details are not described herein again.

Referring to FIG. 6, FIG. 6 is a second structural diagram of a network side device according to an embodiment of the present disclosure. As shown in FIG. 6, the network side device 600 includes: a processor 601, a memory 602, a user interface 603, a transceiver 604, and a bus interface.

In this embodiment of the present disclosure, the network side device 600 further includes a computer program that is stored in the memory 602 and that can run on the processor 601. When the computer program is executed by the processor 601, the following steps are implemented:

sending first synchronization broadcast signal block measurement timing configuration SMTC configuration information, where the first SMTC configuration information is used by a terminal in an idle state or an inactive state.

Optionally, the first SMTC configuration information includes at least one of the following parameters:

a period parameter of the synchronization broadcast signal block, an offset parameter of the synchronization broadcast signal block, a window location parameter of an SMTC window, or a window length parameter of an SMTC window.

Optionally, when the computer program is executed by the processor 601, the following steps may be further performed:

when a terminal in a connected state is released to an idle state or an inactive state in a cell, sending a RRC connection release message, where the RRC connection release message carries first SMTC configuration information corresponding to a frequency; or

when a terminal in an idle state or an inactive state camps on a cell, broadcasting a system broadcasting message, where the system broadcasting message carries the first SMTC configuration information corresponding to a frequency, where

the cell is an LTE cell or a NR cell.

In FIG. 6, a bus architecture may include any quantity of interconnected buses and bridges, which are specifically connected together by various circuits of one or more processors represented by the processor 601 and a memory represented by the memory 602. The bus architecture may further connect together various other circuits of a peripheral device, a voltage stabilizer, a power management circuit, and the like, which are known in this art and will not be further described herein. The bus interface provides an interface. The transceiver 604 can include a plurality of elements, namely a transmitter and a receiver, providing units in communication with various other devices on the transmission medium. For different user equipment, the user interface 603 may alternatively be an interface for externally and internally connecting required equipment. The connected equipment includes but is not limited to a keypad, a display, a speaker, a microphone, a joystick, and the like.

The processor 601 is responsible for management of a bus architecture and general processing. The memory 602 may store data used when the processor 601 performs an operation.

The network side device 600 can implement each process implemented by the network side device in the method embodiment in FIG. 2 in the present disclosure. To avoid repetition, details are not described herein again.

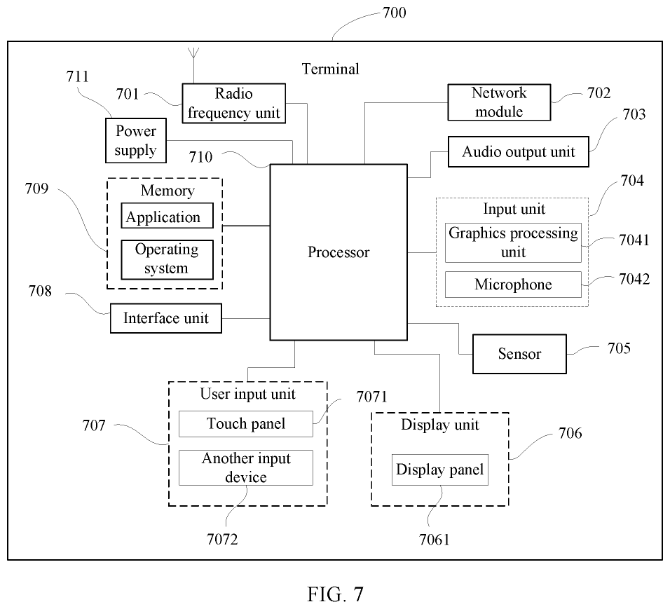

Referring to FIG. 7, FIG. 7 is a second structural diagram of a terminal according to an embodiment of the present disclosure. The terminal may be a schematic structural diagram of hardware of a terminal for implementing the embodiments of the present disclosure. As shown in FIG. 7, the terminal 700 includes but is not limited to: a radio frequency unit 701, a network module 702, an audio output unit 703, an input unit 704, a sensor 705, a display unit 706, a user input unit 707, an interface unit 708, a memory 709, a processor 710, a power supply 711, and the like. Those skilled in the art may understand that the terminal structure shown in FIG. 7 does not constitute a limitation to the terminal. The terminal may include more or fewer components than those shown in the figure, or some components may be combined, or there may be a different component arrangement. In the embodiments of the present disclosure, the terminal includes, but is not limited to, a mobile phone, a tablet computer, a notebook computer, a palmtop computer, a vehicle-mounted terminal, a wearable device, a pedometer, or the like.

The radio frequency unit 701 is configured to:

receive first SMTC configuration information of a first cell, where the first SMTC configuration information is used to indicate a first location of a synchronization broadcast signal block of the first cell.

The processor 710 is configured to:

when the terminal is in an idle state or an inactive state, read or measure a synchronization broadcast signal block of the first cell according to the first SMTC configuration information.

Optionally, the first SMTC configuration information includes at least one of the following parameters:

a period parameter of the synchronization broadcast signal block, an offset parameter of the synchronization broadcast signal block, a window location parameter of an SMTC window, or a window length parameter of an SMTC window.

Optionally, the radio frequency unit 701 is further configured to:

when a terminal in a connected state is released to an idle state or an inactive state in a cell, receive an RRC connection release message, where the RRC connection release message carries first SMTC configuration information corresponding to a frequency; or

when a terminal in an idle state or an inactive state camps on a cell, receive a system broadcasting message, where the system broadcasting message carries the first SMTC configuration information corresponding to a frequency, where

the cell is an LTE cell or a NR cell.

Optionally, the radio frequency unit 701 is further configured to:

receive second SMTC configuration information of a second cell, where the second SMTC configuration information is used to indicate a second location of a synchronization broadcast signal block of the second cell; and

The processor 710 is further configured to:

when the second SMTC configuration information is different from the first SMTC configuration information, update an SMTC configuration of the terminal to the second SMTC configuration information.

It should be noted that the foregoing terminal 700 in this embodiment can implement each process in the foregoing method embodiments in the embodiments of the present disclosure, and achieve same beneficial effects. To avoid repetition, details are not described herein again

It should be understood that in some embodiments of the present disclosure, the radio frequency unit 701 can be configured to receive and send information or receive and send signal during calls. Specifically, the radio frequency unit receives downlink data from a base station, and transmits the downlink data to the processor 710 for processing. In addition, the radio frequency unit sends uplink data to the base station. Generally, the radio frequency unit 701 includes but is not limited to an antenna, at least one amplifier, a transceiver, a coupler, a low noise amplifier, a duplexer, or the like. In addition, the radio frequency unit 701 can further communicate with another device via a wireless communication system and network.

The terminal provides a user with wireless broadband Internet access through the network module 702, for example, helps the user send and receive emails, browse web pages, and access streaming media.

The audio output unit 703 may convert audio data received by the radio frequency unit 701 or the network module 702 or stored in the memory 709 into an audio signal and output the audio signal as a sound. In addition, the audio output unit 703 can also provide audio output related to a specific function performed by the terminal 700 (for example, call signal receiving sound or message receiving sound). The audio output unit 703 includes a speaker, a buzzer, a telephone receiver, and the like.

The input unit 704 is configured to receive audio or video signals. The input unit 704 may include a graphics processing unit (GPU) 7041 and a microphone 7042. The graphics processing unit 7041 processes image data of a static image or a video obtained by an image capture apparatus (such as, a camera) in a video capture mode or an image capture mode. A processed image frame may be displayed on the display unit 706. The image frame processed by the graphics processing unit 7041 can be stored in the memory 709 (or another storage medium) or sent by the radio frequency unit 701 or the network module 702. The microphone 7042 can receive sound, and can process such sound into audio data. The processed audio data can be converted, in a telephone calling mode, into a format that can be sent by the radio frequency unit 701 to a mobile communications base station for output.

The terminal 700 further includes at least one sensor 705, such as a light sensor, a motion sensor, and other sensors. Specifically, the light sensor includes an ambient light sensor and a proximity sensor, where the ambient light sensor can adjust brightness of the display panel 7061 according to brightness of ambient light, and the proximity sensor can turn off the display panel 7061 and/or backlight when the terminal 700 moves towards the ear. As a type of the motion sensor, an accelerometer sensor may detect magnitude of an acceleration in each direction (generally three axes), and may detect magnitude and a direction of gravity when being static. The accelerometer sensor may be configured to recognize a terminal gesture (for example, switching between a landscape mode and a portrait mode, a related game, or magnetometer posture calibration), a function related to vibration recognition (for example, a pedometer or a strike), or the like. The sensor 705 may further include a fingerprint sensor, a pressure sensor, an iris sensor, a molecular sensor, a gyroscope, a barometer, a hygrometer, a thermometer, an infrared sensor, and the like. This is not described herein again.

The display unit 706 is configured to display information entered by the user or information provided for the user. The display unit 706 may include the display panel 7061, and the display panel 7061 may be configured in a form of a liquid crystal display (LCD), an organic light-emitting diode (OLED), or the like.

The user input unit 707 can be configured to receive input numeric or character information, and generate key signal inputs related to user settings and function control of the terminal. Specifically, the user input unit 707 includes a touch panel 7071 and another input device 7072. The touch panel 7071, also called a touch screen, can collect a touch operation of the user on or near the touch panel 7071 (for example, an operation performed by the user with any suitable object or accessory such as a finger or a stylus on or near the touch panel 7071). The touch panel 7071 may include two parts: a touch detection apparatus and a touch controller. The touch detection apparatus detects a touch position of the user, detects a signal brought by the touch operation, and sends the signal to the touch controller. The touch controller receives touch information from the touch detection apparatus, converts the touch information into touch point coordinates, sends the touch point coordinates to a processor 710, and receives and executes a command sent by the processor 710. In addition, the touch panel 7071 may be of a resistive type, a capacitive type, an infrared type, a surface acoustic wave type, or the like. In addition to the touch panel 7071, the user input unit 707 may further include the another input device 7072. Specifically, the another input device 7072 may include but is not limited to a physical keyboard, function keys (such as a volume control key and an on/off key), a trackball, a mouse, and a joystick. Details are not described herein.

Further, the touch panel 7071 may cover the display panel 7061. After detecting the touch operation on or near the touch panel 7071, the touch panel 7071 transmits the touch operation to the processor 710 to determine a type of a touch event, and then the processor 710 provides corresponding visual output on the display panel 7061 based on the type of the touch event. In FIG. 7, the touch panel 7071 and the display panel 7061 are used as two independent components to implement input and output functions of the terminal. However, in some embodiments, the touch panel 7071 and the display panel 7061 may be integrated to implement the input and output functions of the terminal. This is not specifically limited herein.

The interface unit 708 is an interface connecting an external apparatus to the terminal 700. For example, the external apparatus may include a wired or wireless headphone port, an external power supply (or a battery charger) port, a wired or wireless data port, a storage card port, a port used to connect to an apparatus having an identity module, an audio input/output (I/O) port, a video I/O port, a headset port, and the like. The interface unit 708 may be configured to receive input (for example, data information and power) from the external apparatus and transmit the received input to one or more elements in the terminal 700, or may be configured to transmit data between the terminal 700 and the external apparatus.

The memory 709 may be configured to store a software program and various data. The memory 709 may mainly include a program storage area and a data storage area. The program storage area may store an operating system, an application program required by at least one function (such as a sound playback function and an image display function), and the like. The data storage area may store data (such as audio data and a phone book) created based on use of the mobile phone, and the like. In addition, the memory 709 may include a high-speed random access memory or a nonvolatile memory, for example, at least one disk storage device, a flash memory, or another volatile solid-state storage device.

The processor 710 is a control center of the terminal. The processor uses various interfaces and lines to connect the various parts of the entire terminal, and performs various functions of the terminal and processes data by running or executing software programs and/or modules stored in the memory 709 and invoking data stored in the memory 709, to monitor the terminal as a whole. The processor 710 may include one or more processing units. Optionally, the processor 710 may be integrated with an application processor and a modem processor. The application processor mainly processes the operating system, the user interface, applications, etc. The modem processor mainly processes wireless communication. It may be understood that the foregoing modem processor may not be integrated into the processor 710.

The terminal 700 may further include a power supply 711 (for example, a battery) that supplies power to various components. Optionally, the power supply 711 may be logically connected to the processor 710 through a power supply management system, to perform functions of managing charging, discharging, and power consumption through the power supply management system.

In addition, the terminal 700 includes some function modules not shown, and details are not described herein again.

Optionally, an embodiment of the present disclosure further provides a terminal, including a processor 710, a memory 709, and a computer program that is stored in the memory 709 and that can run on the processor 710. When the computer program is executed by the processor 710, each process of the foregoing receiving method embodiments can be implemented, and a same technical effect can be achieved. To avoid repetition, details are not described herein again.

An embodiment of the present disclosure further provides a computer readable storage medium, storing a computer program, where when the computer program is executed by the processor, the processes of the foregoing embodiments of the configuration method or the receiving method are implemented, and the same technical effects can be achieved. To avoid repetition, details are not described herein again. The computer readable storage medium may be a read-only memory (ROM), a random access memory (RAM), a magnetic disk, a compact disc, or the like.

It should be noted that the terms “include”, “comprise” or any other variants thereof herein are intended to cover a non-exclusive inclusion, so that a process, a method, an article or equipment that includes a list of elements not only includes those elements, but also includes another element not expressly listed, or an element inherent to such a process, a method, an article, or equipment. In the absence of more restrictions, an element defined by the statement “including a . . . ” does not exclude presence of another same element in a process, method, article, or apparatus that includes the element.

By means of the foregoing description of the implementations, a person skilled in the art may clearly understand that the method in the foregoing embodiments may be implemented by software with a necessary general hardware platform. Certainly, the method in the foregoing embodiments may also be implemented by hardware. In some embodiments, the technical solutions of the present disclosure essentially, or the part contributing to the related technologies may be implemented in a form of a software product. The computer software product is stored in a storage medium (for example, a ROM/RAM, a magnetic disk, or a compact disc), and includes a plurality of instructions for instructing a terminal (which may be a mobile phone, a computer, a server, an air conditioner, a network device, or the like) to perform the method described in the embodiments of the present disclosure.

The embodiments of the present disclosure are described above with reference to the accompanying drawings, but the present disclosure is not limited to the foregoing specific implementations. The foregoing specific implementations are merely schematic instead of restrictive. Under enlightenment of the present disclosure, a person of ordinary skills in the art may make many forms without departing from aims of the present disclosure and the protection scope of claims, all of which fall within the protection of the present disclosure.

What is claimed is:

1. A configuration method, applied to a network side device, comprising:
sending first synchronization signal/physical broadcast channel (SS/PBCH) block measurement timing configuration (SMTC) configuration information, wherein the first SMTC configuration information is used by a terminal in an idle state or an inactive state.

2. The configuration method according to claim 1, wherein the first SMTC configuration information comprises at least one of the following parameters:
a period parameter of the synchronization broadcast signal block, an offset parameter of the synchronization broadcast signal block, a window location parameter of an SMTC window, or a window length parameter of the SMTC window.

3. The configuration method according to claim 1, wherein sending the first SMTC configuration information comprises:
when a terminal in a connected state is released to an idle state or an inactive state in a cell, sending a radio resource control (RRC) connection release message, wherein the RRC connection release message carries the first SMTC configuration information corresponding to a frequency; or
when a terminal in an idle state or an inactive state camps on a cell, broadcasting a system broadcasting message, wherein the system broadcasting message carries the first SMTC configuration information corresponding to the frequency, wherein
the cell is a long term evolution (LTE) cell or a new radio (NR) cell.

4. A receiving method, applied to a terminal, comprising:
receiving first SMTC configuration information of a first cell; and
when the terminal is in an idle state or an inactive state, reading or measuring a synchronization broadcast signal block of the first cell according to the first SMTC configuration information.

5. The receiving method according to claim 4, wherein the first SMTC configuration information comprises at least one of the following parameters:
a period parameter of the synchronization broadcast signal block, an offset parameter of the synchronization broadcast signal block, a window location parameter of an SMTC window, or a window length parameter of the SMTC window.

6. The receiving method according to claim 4, wherein receiving the first SMTC configuration information of the first cell comprises:
when a terminal in a connected state is released to an idle state or an inactive state in a cell, receiving an RRC connection release message, wherein the RRC connection release message carries the first SMTC configuration information corresponding to a frequency; or
when a terminal in an idle state or an inactive state camps on a cell, receiving a system broadcasting message, wherein the system broadcasting message carries the first SMTC configuration information corresponding to the frequency, wherein
the cell is an LTE cell or a NR cell.

7. The receiving method according to claim 4, after receiving the first SMTC configuration information of the first cell, further comprising:
receiving second SMTC configuration information of a second cell, wherein the second SMTC configuration information is used to indicate a second location of a synchronization broadcast signal block of the second cell; and
when the second SMTC configuration information is different from the first SMTC configuration information, updating an SMTC configuration of the terminal to the second SMTC configuration information.

8. A terminal, comprising a processor, a memory, and a computer program that is stored in the memory and that can run on the processor, wherein the computer program, when executed by the processor, causes the processor to:
receive first SMTC configuration information of a first cell; and
when the terminal is in an idle state or an inactive state, read or measure a synchronization broadcast signal block of the first cell according to the first SMTC configuration information.

9. The terminal according to claim 8, wherein the first SMTC configuration information comprises at least one of the following parameters:
a period parameter of the synchronization broadcast signal block, an offset parameter of the synchronization broadcast signal block, a window location parameter of an SMTC window, or a window length parameter of the SMTC window.

10. The terminal according to claim 8, wherein, to receive the first SMTC configuration information of the first cell, the computer program, when executed by the processor, further causes the processor to:
when a terminal in a connected state is released to an idle state or an inactive state in a cell, receive an RRC connection release message, wherein the RRC connection release message carries the first SMTC configuration information corresponding to a frequency; or
when a terminal in an idle state or an inactive state camps on a cell, receive a system broadcasting message, wherein the system broadcasting message carries the first SMTC configuration information corresponding to the frequency, wherein
the cell is an LTE cell or a NR cell.

11. The terminal according to claim 8, wherein the computer program, when executed by the processor, further causes the processor to:
after receiving the first SMTC configuration information of the first cell, receive second SMTC configuration information of a second cell, wherein the second SMTC configuration information is used to indicate a second location of a synchronization broadcast signal block of the second cell; and
when the second SMTC configuration information is different from the first SMTC configuration information, update an SMTC configuration of the terminal to the second SMTC configuration information.
